(19) United States
(12) Patent Application Publication
(10) Pub. No.: US 2012/0152544 A1
(43) Pub. Date: Jun. 21, 2012

(54) COLD WEATHER COMPATIBLE CROSSLINKER SOLUTION

(76) Inventors: Michael D. Parris, Richmond, TX (US); Li Jiang, Katy, TX (US); Don Williamson, Katy, TX (US)

(21) Appl. No.: 13/313,482

(22) Filed: Dec. 7, 2011

Related U.S. Application Data
(60) Provisional application No. 61/423,762, filed on Dec. 16, 2010.

(51) Int. Cl. E21B 43/27; C08F 8/00; C08B 37/00; C09K 8/60

(52) U.S. Cl. 166/300; 507/266; 507/241; 507/260; 507/211; 507/224; 507/219; 507/225; 507/226; 525/330.3; 525/329.4; 525/328.2; 525/337; 536/114

(57) ABSTRACT

Disclosed herein is a well treatment fluid comprising an aqueous solution comprising greater than or equal to about 1 wt % boron, at least 5 wt % of a co-solvent, and greater than or equal to about 5 wt % sodium hydroxide, potassium hydroxide, or a combination thereof, wherein the co-solvent comprises glycerol, ethylene glycol, propylene glycol, or a combination thereof. Methods of using the well treatment fluid are also disclosed.

### CROSS REFERENCE TO RELATED APPLICATIONS

This application claims priority to and the benefit of provisional application U.S. 61/423,762, filed Dec. 16, 2010, which is hereby incorporated herein by reference in its entirety.

### BACKGROUND

The statements in this section merely provide background information related to the present disclosure and may not constitute prior art.

Borate-crosslinked guar and borate-crosslinked HPG fluids are widely used in hydraulic fracturing. A boron-containing crosslinker can be delivered in several forms; as a dry solid, such as in granules, as solids suspended in a liquid media, such as a concentrated slurry of finely-ground ulexite, or in a solution.

Each form has certain advantages and disadvantages. For example, solid crosslinkers may provide the highest concentration of boron per unit weight of crosslinker, and, at the same time, not be subject to freezing conditions. These solids must be added and mixed to the polymer-containing fluids stream. Accurately metering and uniformly dispersing solids into the fluid stream at the wellsite is technically and logistically more challenging than the same operation with liquids. Additionally, granular solids may agglomerate or “cake”, introducing further difficulties to metering and dispersing into a fluid stream.

Concentrated suspensions, also known as slurries, of finely ground solid particles in a fluid carrier also has certain advantages and disadvantages. Concentration of the suspended material is an advantage. However, one of the most problematic issues with this form is the settling and/or stratification of the suspended solids in the slurry. Paints are an example of a concentrated suspension, where settling of the pigments and latex particles occurs. Settling of a concentrated crosslinker suspension can inhibit the flow of the material from the container discharge, which is usually located at the bottom. Depending on the settled or packed state, slurry and container characteristics, it can be very difficult to re-suspend the slurry to re-establish an homogenous blend. The viscosities of concentrated slurries are increased by factors such as solid volume fraction and temperature. If the suspending liquid thickens with lowering temperature, there may be a pronounced rise in the slurry viscosity, rendering it too viscous for metering purposes at the wellsite.

Liquid solutions which are stable to storage and usage conditions may be transferred and metered accurately by a variety of pumps. Liquid flow meters are routinely used to measure flow rate and to totalize pumped liquids. However, liquids are subject to freezing, and may not be useful without employing heaters to keep the fluid warm, which results in considerable costs and engineering concerns. Even with heaters, liquids which are transferred in hoses exposed to cold environments, or which may sit static in those hoses or exposed pumps, may cause interruption in the fracturing operations.

Accordingly, there is a need for a boron-containing crosslinker solution which remains liquid and flowable in very cold conditions.

### SUMMARY

The instant disclosure is directed to a boron containing crosslinker which is stable under a variety of storage and use conditions. A method of treating a well using the boron containing crosslinker is also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE SEVERAL VIEWS OF THE DRAWINGS

FIG. 1 is a graphical representation showing the viscosity of the well treatment fluid according to an embodiment of instant disclosure as a function of percent KOH of the total amount of KOH and NaOH present, when measured at 3° C. (37° F.); and

FIG. 2 is a graphical representation showing rheological profiles of embodiments used in a fracturing fluid modality.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In this detailed description, each numerical value should be read once as modified by the term “about” (unless already expressly so modified), and then read again as not so modified unless otherwise indicated in context. Also, in this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. The fracturing methods otherwise use conventional techniques known in the art.

A material is said to be “dispersible” in a liquid medium if the material is at least partially soluble in the liquid medium, i.e., does not undergo Tyndall scattering, or which forms a colloid, an emulsion, or the like. As used herein, the term “dispersible” refers to a physical phenomenon of homogenous distribution of chemically inert solid particles, stabilized by the expulsion force of their identical surface charges. This does not involve “dissolution”, which is commonly regarded as a chemical process with new hydrated species formed.

A cross-linkable polymer is defined as a polymer which reacts with a crosslinker, e.g., boron, to produce interpolymer chain linkages, intrapolymer chain linkages, or both. A crosslinked polymer may be characterized by an increase in viscosity relative to the same polymer in the absence of crosslinking.

An advantage of this crosslinker is that it contains adequate alkalinity to produce a temperature-stable gel without the further addition of alkaline substances. This feature eliminates the separate transport and addition at the wellsite to the fluid stream of another chemical, streamlining the operation.

As used herein a “solution” refers to a heterogeneous composition having a solute dissolved in a solvent. Accordingly, an aqueous solution refers to a solute dissolved in a solvent comprising water.

As used herein, the term “liquid medium” refers to a material which is liquid under the conditions of use. For example, a liquid medium may refer to water, and/or an organic solvent which is above the freezing point and below the boiling point of the material at a particular pressure. A liquid medium may also refer to a supercritical fluid.

As used herein, the term “polymer” refers to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form the monomer. However, for ease of reference the phrase comprising the (respective) monomer or the like is used as shorthand.

In an embodiment, a well treatment fluid comprises an aqueous solution comprising greater than or equal to about 1 wt % boron, at least 5 wt % of a co-solvent, and greater than or equal to about 5 wt % sodium hydroxide, potassium hydroxide, or a combination thereof. Accordingly, in an embodiment, the well treatment fluid comprises water and at least one co-solvent. In an embodiment, the co-solvent comprises glycerol, ethylene glycol, propylene glycol, or a combination thereof. In an embodiment, the co-solvent comprises glycerol.

In an embodiment, the boron present in the well treatment fluid according to the instant disclosure results from boric acid, a salt of boric acid, borax, or a combination thereof. Accordingly, the boron present in the well treatment fluid is present as the dissolved form of boric acid, a salt of boric acid, borax, or a combination thereof under the conditions present in the well treatment fluid.

In an embodiment, the well treatment fluid comprises an aqueous solution comprising greater than or equal to about 1 wt % boron, or greater than or equal to about 2 wt % boron, or greater than or equal to about 3 wt % boron, or greater than or equal to about 4 wt % boron, or greater than or equal to about 5 wt % boron, and less than or equal to about 10 wt % boron.

In an embodiment, the well treatment fluid comprises an aqueous solution comprising greater than or equal to about 5 wt % of a co-solvent, or greater than or equal to about 10 wt % co-solvent, or greater than or equal to about 15 wt % co-solvent, or greater than or equal to about 20 wt % co-solvent, or greater than or equal to about 30 wt % co-solvent, and less than or equal to about 50 wt % co-solvent. In an embodiment, the co-solvent comprises glycerol, ethylene glycol, propylene glycol, or a combination thereof. In an embodiment, the co-solvent comprises glycerol, or consists essentially of glycerol.

In an embodiment, the well treatment fluid has a viscosity of less than or equal to about 400 cP at about 3° C. (37° F.), or less than or equal to about 350 cP at about 3° C., or less than or equal to about 300 cP at about 3° C., or less than or equal to about 250 cP at about 3° C., or less than or equal to about 200 cP at about 3° C., or less than or equal to about 150 cP at about 3° C., or less than or equal to about 100 cP at about 3° C., or less than or equal to about 50 cP at about 3° C.

Solids formation or other forms of phase separation under any anticipated storage condition renders an oilfield well treatment fluid or additive less desirable, as it requires some operation, either heating, stirring, dilution, or some combination of above to re-dissolve the solids. These operations are time consuming, and may delay the process at the wellsite, resulting in lost revenue. In an embodiment, the well treatment fluid is a homogeneous solution after storage at −40° C. for at least one (1) week, or after storage at −40° C. for at least one (1) month. Accordingly, the well treatment fluid does not produce crystals or undergo phase separation after aging at −40° C. for the specified period of time.

In an embodiment, the well treatment fluid further comprises from about 0.01 wt % to less than or equal to about 10 wt % of methanol, ethanol, isopropanol, propanol, a colloidal silica dispersion, or a combination thereof. In an embodiment, the well treatment fluid further comprises from about 0.01 wt % to less than or equal to about 10 wt % of methanol, ethanol, isopropanol, or propanol, or from about 0.01 wt % to less than or equal to about 5 wt %, or from about 0.01 wt % to less than or equal to about 3 wt %, or from about 0.01 wt % to less than or equal to about 2 wt %, or from about 0.01 wt % to less than or equal to about 1 wt % methanol, ethanol, isopropanol, or propanol.

In an embodiment, the well treatment further comprises from about 0.01 wt % to less than or equal to about 1 wt % of a chelating agent selected from the group consisting of: ethylenediaminetetraacetic acid, ethylene glycol tetraacetic acid, 1,2-bis(o-aminophenoxy)ethanetetraacetic acid, nitrilotriacetic acid, 4-hydroxybenzenesulfonic acid, and a combination thereof.

In an embodiment, the well treatment fluid may further comprise a cross-linkable polymer. In an embodiment the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

In an embodiment, a method of treating a wellbore comprises introducing a well treatment fluid according to the instant disclosure into a wellbore penetrating a subterranean formation, wherein the well treatment fluid comprises an aqueous solution comprising greater than or equal to about 1 wt % boron, at least 5 wt % of a co-solvent, and greater than or equal to about 5 wt % sodium hydroxide, potassium hydroxide, or a combination thereof, and wherein the co-solvent is glycerol, ethylene glycol, propylene glycol, or a combination thereof.

In an embodiment, a method of treating a wellbore comprises contacting a crosslinker solution with a mixture comprising a cross-linkable polymer to produce a well treatment fluid comprising a crosslinked polymer, and introducing the well treatment fluid into the wellbore penetrating a subterranean formation, wherein the crosslinker solution comprises an aqueous solution comprising greater than or equal to about 1 wt % boron, at least 5 wt % of a co-solvent, and greater than or equal to about 5 wt % sodium hydroxide, potassium hydroxide, or a combination thereof, wherein the co-solvent is glycerol, ethylene glycol, propylene glycol, or a combination thereof and wherein the boron results from boric acid, a salt of boric acid, borax, or a combination thereof. In an embodiment, the cross-linkable polymer according to a method disclosed herein comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

In an embodiment, the well treatment fluid disclosed herein may be utilized as a crosslinker solution, which may be combined with a polymer to produce a crosslinked polymer. In an embodiment, the well treatment fluid comprises an amount of alkalinity (e.g., —OH) adequate to produce a temperature-stable gel or other crosslinked polymer species without the need for further addition of alkaline substances. This feature eliminates the separate transport and addition at the wellsite to the fluid stream of another chemical, streamlining the operation.

In an embodiment, a method of reducing phase separation in a well treatment fluid comprises combining an amount of a co-solvent with an aqueous solution comprising greater than or equal to about 1 wt % boron and greater than or equal to about 5 wt % sodium hydroxide, potassium hydroxide, or a combination thereof, to produce the well treatment fluid comprising an aqueous solution comprising greater than or equal to about 1 wt % boron, at least 5 wt % of the co-solvent, and greater than or equal to about 5 wt % sodium hydroxide, potassium hydroxide, or a combination thereof; wherein the co-solvent is glycerol, ethylene glycol, propylene glycol, or a combination thereof.

In an embodiment, a method of forming a crosslinked polymer comprises contacting a crosslinkable polymer with a crosslinking solution to produce the crosslinked polymer, wherein the crosslinking solution comprises an aqueous solution comprising greater than or equal to about 1 wt % boron, at least 5 wt % of the co-solvent, and greater than or equal to about 5 wt % sodium hydroxide, potassium hydroxide, or a combination thereof; wherein the co-solvent is glycerol, ethylene glycol, propylene glycol, or a combination thereof. Accordingly, in an embodiment, the amount of sodium hydroxide, potassium hydroxide, or a combination thereof present in the crosslinker solution is sufficient to adjust the pH of the target solution comprising the crosslinkable polymer to a basic pH without having to add additional caustic to the solution during the crosslinking.

In an embodiment, a method of treating a wellbore comprises introducing a crosslinker solution and a mixture comprising a cross-linkable polymer into a wellbore penetrating a subterranean formation, to produce a well treatment fluid comprising a crosslinked polymer within the wellbore. In an embodiment, the crosslinker solution and the mixture comprising a cross-linkable polymer are introduced into the wellbore sequentially, simultaneously, or a combination thereof. In an embodiment, the crosslinker solution comprises an aqueous solution comprising greater than or equal to about 3 wt % boron, at least 10 wt % of a co-solvent, and greater than or equal to about 10 wt % sodium hydroxide, potassium hydroxide, or a combination thereof; wherein the co-solvent is glycerol, ethylene glycol, propylene glycol, or a combination thereof; and wherein the boron results from boric acid, a salt of boric acid, borax, or a combination thereof. In an embodiment, the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

In an embodiment, the well treatment fluid may include viscoelastic surfactants (VES). Nonlimiting examples of suitable viscoelastic surfactant materials are described in U.S. Pat. Nos. 5,979,557 (Card et al.); 6,435,277 (Qu et al.) and 6,703,352 (Dahayanake et al.), which are each incorporated herein by reference in their entireties. The viscoelastic surfactants may include cationic surfactants, amphoteric surfactants, zwitterionic surfactants, including betaine surfactants, anionic surfactants and combinations of these.

The well treatment fluid may further comprise friction reducing surfactant formulations and enhancers. Such friction reduction enhancers and friction reduction materials are described in US 2008-0064614 A1, which is incorporated by reference herein in its entirety. Suitable friction reducing surfactants may include cationic surfactants, amphoteric surfactants, zwitterionic surfactants, anionic surfactants and combinations of these. Specific examples of suitable friction reducing surfactants, when used with a primary friction reduction enhancer, include cetyl trimethyl ammonium chloride and tallow trimethyl ammonium chloride. The polymeric friction reduction enhancers are polymers, which may be either cationic or anionic.

Optionally, a monomeric friction reduction enhancer may also be used in combination with the friction reducing surfactant. Such monomeric drag reduction enhancers are organic counterions, and may include monomers or oligomers of the polymeric drag reduction enhancer. An example of these friction reduction enhancers is (sodium) polynaphthalene sulfonate, as the polymeric friction reduction enhancer, and (sodium) naphthalene sulfonate, as the monomeric friction reduction enhancer.

Co-surfactants, which may have slightly different chemical natures from the main surfactant, may also be used. Thus, for example, the co-surfactant may be cationic if the main surfactant is anionic. The well treatment fluid disclosed herein may be compatible with one or more heavy brines, such as seawater, NaCl, KCl, NaBr, CaBr₂, CaCl₂, and the like.

In an embodiment, the well treatment fluid may further comprise an organic solvent selected from the group consisting of diesel oil, kerosene, paraffinic oil, crude oil, LPG, toluene, xylene, ether, ester, mineral oil, biodiesel, vegetable oil, animal oil, and mixtures thereof. Specific examples of suitable organic solvent include acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibuthylether, dimethyl-formamide (DMF), dimethyl sulfoxide (DMSO), dioxane, ethyl acetate, heptanes, Hexamethylphosphoramide (HMPA), Hexamethylphosphorous triamide (HMPT), hexane, methyl t-butyl ether (MTBE), methylene chloride, N-methyl-2-pyrrolidinone (NMP), nitromethane, pentane, Petroleum ether (ligroine), pyridine, tetrahydrofuran (THF), toluene, triethyl amine, o-xylene, m-xylene, p-xylene, and the like.

Further solvents include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as vaseline oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Further solvents also include terpenes such as d-limonene, 1-limonene, dipentene, myrcene, alpha-pinene, linalool and mixtures thereof.

Further exemplary organic liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono (alkyl or aryl)ethers of glycols, mono (alkyl or aryl)ethers of polyalkylene glycols and poly(alkyl and/or aryl)ethers of polyalkylene glycols, monoalkanoate esters of glycols, monoalkanoate esters of polyalkylene glycols, polyalkylene glycol esters like poly(alkyl and/or aryl) esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The organic liquid may also be selected from the group consisting of tetrahydrofuran, dioxane, dioxolane, methyltetrahydrofuran, dimethylsulfone, tetramethylene sulfone and thiophen.

In an embodiment, a method of fracturing a subterranean formation comprises providing a fracturing fluid comprising the well treatment fluid according to the present disclosure, and introducing the fracturing fluid into the subterranean formation at a pressure sufficient to create or extend at least one fracture in the subterranean formation.

The well treatment fluid according to the present disclosure may be used for carrying out a variety of subterranean treatments, including, but not limited to, drilling operations, fracturing treatments, and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the reservoir and the wellbore and also to increase the surface area available for fluids to flow into the wellbore.

Accordingly, the present invention provides the following embodiments of the invention:

A. A well treatment fluid comprising an aqueous solution comprising greater than or equal to about 1 wt % boron, at least 5 wt % of a co-solvent, and greater than or equal to about 5 wt % sodium hydroxide, potassium hydroxide, or a combination thereof, wherein the co-solvent comprises glycerol, ethylene glycol, propylene glycol, or a combination thereof.

B. The well treatment fluid according to embodiment A, wherein the boron results from boric acid, a salt of boric acid, borax, or a combination thereof.

C. The well treatment fluid according to embodiment A or B, having a viscosity of less than or equal to about 200 cP at about 3° C. (37° F.).

D. The well treatment fluid according to embodiment A, B, or C, wherein the fluid is a homogeneous solution after storage at −40° C. for 1 week.

E. The well treatment fluid according to embodiment A, B, C, or D, further comprising from about 0.01 wt % to less than or equal to about 10 wt % of methanol, ethanol, isopropanol, propanol, a colloidal silica dispersion, or a combination thereof.

F. The well treatment fluid according to embodiment A, B, C, D, or E, further comprising from about 0.01 wt % to less than or equal to about 1 wt % of a chelating agent selected from the group consisting of: ethylenediaminetetraacetic acid, ethylene glycol tetraacetic acid, 1,2-bis(o-aminophenoxy)ethanetetraacetic acid, nitrilotriacetic acid, 4-hydroxybenzenesulfonic acid, and a combination thereof.

G. The well treatment fluid according to embodiment A, B, C, D, E, or F, further comprising a cross-linkable polymer comprising guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

H. A method of treating a wellbore comprising:

introducing a well treatment fluid into a wellbore penetrating a subterranean formation, wherein the well treatment fluid comprises an aqueous solution comprising greater than or equal to about 1 wt % boron, at least 5 wt % of a co-solvent, and greater than or equal to about 5 wt % sodium hydroxide, potassium hydroxide, or a combination thereof, and wherein the co-solvent is glycerol, ethylene glycol, propylene glycol, or a combination thereof.

I. The method according to embodiment H, wherein the boron results from boric acid, a salt of boric acid, borax, or a combination thereof.

J. The method according to embodiment H or I, wherein the well treatment fluid has a viscosity of less than or equal to about 200 cP at about 3° C. (37° F.).

K. The method according to embodiment H, I, or J, wherein the well treatment fluid is a homogeneous solution after storage at −40° C. for 1 week.

L. The method according to embodiment H, I, J, or K, wherein the well treatment fluid further comprises from about 0.01 wt % to less than or equal to about 10 wt % of methanol, ethanol, isopropanol, propanol, a colloidal silica dispersion, or a combination thereof.

M. The method according to embodiment H, I, J, K, or L, wherein the well treatment fluid further comprises from about 0.01 wt % to less than or equal to about wt % of a chelating agent selected from the group consisting of: ethylenediaminetetraacetic acid, ethylene glycol tetraacetic acid, 1,2-bis(o-aminophenoxy)ethanetetraacetic acid, nitrilotriacetic acid, 4-hydroxybenzenesulfonic acid, and a combination thereof.

N. The method according to embodiment H, I, J, K, L, or M, wherein the well treatment fluid further comprises a cross-linkable polymer.

O. The method according to embodiment H, I, J, K, L, M, or N, wherein the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

P. A method of treating a wellbore comprising:

contacting a crosslinker solution with a mixture comprising a cross-linkable polymer to produce a well treatment fluid comprising a crosslinked polymer, and

introducing the well treatment fluid into the wellbore penetrating a subterranean formation, wherein the crosslinker solution comprises an aqueous solution comprising greater than or equal to about 3 wt % boron, at least 10 wt % of a co-solvent, and greater than or equal to about 10 wt % sodium hydroxide, potassium hydroxide, or a combination thereof, wherein the co-solvent is glycerol, ethylene glycol, propylene glycol, or a combination thereof and wherein the boron results from boric acid, a salt of boric acid, borax, or a combination thereof.

Q. The method according to embodiment P, wherein the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

R. A method of treating a wellbore comprising:

introducing a crosslinker solution and a mixture comprising a cross-linkable polymer into a wellbore penetrating a subterranean formation, to produce a well treatment fluid comprising a crosslinked polymer within the wellbore;

wherein the crosslinker solution and the mixture comprising a cross-linkable polymer are introduced into the wellbore sequentially, simultaneously, or a combination thereof;

wherein the crosslinker solution comprises an aqueous solution comprising greater than or equal to about 3 wt % boron, at least 10 wt % of a co-solvent, and greater than or equal to about 10 wt % sodium hydroxide, potassium hydroxide, or a combination thereof; wherein the co-solvent is glycerol, ethylene glycol, propylene glycol, or a combination thereof; and wherein the boron results from boric acid, a salt of boric acid, borax, or a combination thereof.

S. The method according to embodiment R, wherein the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

T. A method of reducing phase separation in a well treatment fluid comprising:

combining an amount of a co-solvent with an aqueous solution comprising greater than or equal to about 1 wt % boron and greater than or equal to about 5 wt % sodium hydroxide, potassium hydroxide, or a combination thereof, to produce the well treatment fluid comprising an aqueous solution comprising greater than or equal to about 1 wt % boron, at least 5 wt % of the co-solvent, and greater than or equal to about 5 wt % sodium hydroxide, potassium hydroxide, or a combination thereof; wherein the co-solvent is glycerol, ethylene glycol, propylene glycol, or a combination thereof.

U. A method of forming a crosslinked polymer comprising:

contacting a crosslinkable polymer with a crosslinking solution to produce the crosslinked polymer, wherein the crosslinking solution comprises an aqueous solution comprising greater than or equal to about 1 wt % boron, at least 5 wt % of the co-solvent, and greater than or equal to about 5 wt % sodium hydroxide, potassium hydroxide, or a combination thereof; wherein the co-solvent is glycerol, ethylene glycol, propylene glycol, or a combination thereof.

### EXAMPLES

In the following examples, various solutions were prepared to produce homogenous solutions, with the exception of Examples 13 and 14, in which a colloidal dispersion of silica (Ludox HS-40, Sigma-Aldrich Corporation, St. Louis, Mo.) was added to an otherwise homogeneous solution. The solutions were then filtered to ensure a homogeneous solution and subjected to aging including cycling from 20° C. down to −40° C. and then up to 20° C. over a 12 hour period for one months time. The samples were then observed for crystallization (i.e., phase separation) after 1 month of thermal aging. The data are shown in Table 1.

TABLE 1

| | Boron | | | | | | | | | | | | | |
|---|---|---|---|---|---|---|---|---|---|---|---|---|---|---|
| | Source | | Co-Solvent | | | | | | | | | Viscosity | | |
| | Boric | | Ethylene | | Caustic | | | | | Other | Total | (cP) | | Crystals |
| Composition | Acid | Borax | Glycol | Glycerol | KOH | NaOH | LiOH | Water | Other | wt % | wt % | at 37° F. | at 77° F. | Formed? |
| Example 1 | 18 | 0 | 0 | 15 | 25 | 0 | 0 | 42 | | | 100 | 47 | 13 | N |
| Example 2 | 18 | 0 | 0 | 15 | 21 | 4.5 | 0 | 41.5 | | | 100 | 68 | 16 | N |
| Example 3 | 18 | 0 | 0 | 15 | 14 | 9 | 0 | 44 | | | 100 | 107 | 16 | N |
| Example 4 | 18 | 0 | 0 | 15 | 7 | 13.5 | 0 | 46.5 | | | 100 | 167 | 25 | N |
| Comparative | 18 | 0 | 0 | 15 | 0 | 18 | 0 | 49 | | 0 | 100 | 249 | 33 | Y |
| Example 5 | | | | | | | | | | | | | | |
| Comparative | 0 | 27.8 | 0 | 15 | 0 | 18 | 0 | 39.2 | | 0 | 100 | NT | NT | Y |
| Example 6 | | | | | | | | | | | | | | |
| Comparative | 18 | 0 | 15 | 15 | 0 | 18 | 0 | 34 | | 0 | 100 | 1621 | 121 | Y |
| Example 7 | | | | | | | | | | | | | | |
| Example 8 | 18 | 0 | 30 | 0 | 0 | 18 | 0 | 34 | | 0 | 100 | 1021 | 80 | N |
| Example 9 | 18 | 0 | 0 | 30 | 0 | 18 | 0 | 34 | | 0 | 100 | 3195 | 172 | N |
| Example 10 | 18 | 0 | 0 | 15 | 0 | 18 | 0 | 48 | methanol | 1 | 100 | 325 | 37 | N |
| Example 11 | 18 | 0 | 0 | 15 | 0 | 18 | 0 | 47 | methanol | 2 | 100 | 332 | 37 | N |
| Example 12 | 18 | 0 | 0 | 15 | 0 | 18 | 0 | 46 | methanol | 3 | 100 | 338 | 37 | N |
| Example 3 | 18 | 0 | 0 | 15 | 0 | 18 | 0 | 46 | Ludox | 3 | 100 | 373 | 41 | N |
| | | | | | | | | | HS-40 | | | | | |
| Example 14 | 18 | 0 | 0 | 15 | 0 | 18 | 0 | 43 | Ludox | 6 | 100 | 530 | 52 | N |
| | | | | | | | | | HS-40 | | | | | |
| Example 15 | 18 | 0 | 0 | 15 | 0 | 18 | 0 | 48.8 | EDTA | 0.2 | 100 | 285 | 34 | N |
| Comparative | 18 | 0 | 0 | 15 | 0 | 0 | 10.8 | 56.2 | EDTA | 0 | 100 | 285 | 34 | N |
| Example 16 | | | | | | | | | | | | | | |
| Comparative | 18 | 0 | 0 | 15 | 7 | 0 | 7.88 | 52.1 | | 0 | 100 | | | Y |
| Example 17 | | | | | | | | | | | | | | |
| Comparative | 18 | 0 | 0 | 15 | 14 | 0 | 5.25 | 47.8 | | 0 | 100 | | | Y |
| Example 18 | | | | | | | | | | | | | | |
| Comparative | 18 | 0 | 0 | 15 | 21 | 0 | 2.63 | 43.4 | | 0 | 100 | | | Y |
| Example 19 | | | | | | | | | | | | | | |

The borax used was borax decahydrate, obtained from US Borax. The EDTA was di-sodium EDTA. Glycerol was 99% purity; boric acid was obtained from US Borax as Optibor TP. The viscosity is reported in cP, and was measured on a Contraves LS-30 at 1 sec⁻¹.

As the data shows, various embodiments according to the present disclosure remain solids-free under the temperature testing program. However, it was observed that only those solutions formulated with potassium hydroxide (KOH) remained flowing at negative 40° C. Importantly, small alcohols, particularly methanol, were also seen to prevent the precipitation of solids during temperature storage testing.

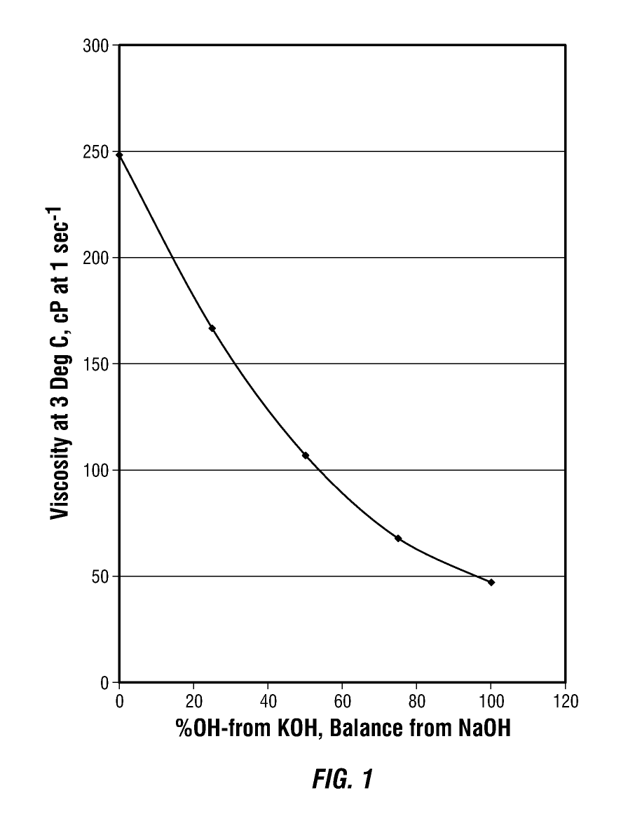

The viscosity of the crosslinker formulations made with blends of NaOH and KOH, where the —OH concentration remained fixed, are shown in FIG. 1, which shows the viscosity of the well treatment fluid of an embodiment, as a function of percent KOH of the total amount of KOH and NaOH present, when measured at 37° F. The total concentration of hydroxyl ion (i.e., —OH wt %) present in the examples was 7.65 wt %. As Comparative Example 16 made with LiOH was solid at this temperature, its viscosity could not be measured similarly, while Comparative Examples 17-19 containing various molar fractions of LiOH—KOH binary mixture all exhibited considerable level of crystallization after being stored overnight at 10° F.

### Crosslinker Solution

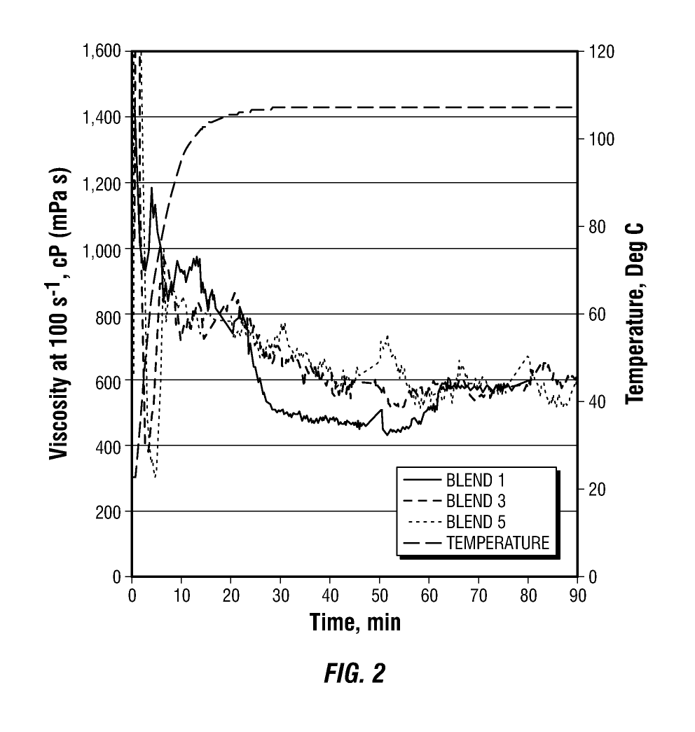

Performance of the well treatment fluid as a crosslinker with alkalinity provided from NaOH, KOH and a blend of the two are shown in FIG. 2. For the three examples in the Figure, all are blended first by hydrating 0.42% wt. guar in Sugar Land, Tex. tap water. Each blend contains 0.2% vol. of a 50% solution of tetramethyl ammonium chloride for clay stabilization, 0.2% vol. of a surfactant for aiding in interfacial tension reduction, and 0.12% wt. sodium thiosulfate as a thermal stabilizer. Each sample also contains 0.3% vol. of Example 1 (Blend 1), Example 3 (Blend 3), or Example 5 (Blend 5) as described in Table 1 above. The well treatment fluid was loaded into a Grace Instrument Company model 5500 rheometer equipped with a rotor #1 and bob #5, and tested according to API Recommended Practice 39 (API-RP39) at 225° F. (107° C.). These examples demonstrate that the three crosslinker solutions perform equivalently when used in a fracturing fluid modality.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

I claim:

1. A well treatment fluid comprising an aqueous solution comprising greater than or equal to about 1 wt % boron, at least 5 wt % of a co-solvent, and greater than or equal to about 5 wt % sodium hydroxide, potassium hydroxide, or a combination thereof, wherein the co-solvent comprises glycerol, ethylene glycol, propylene glycol, or a combination thereof.

2. The well treatment fluid of claim 1, wherein the boron results from boric acid, a salt of boric acid, borax, or a combination thereof.

3. The well treatment fluid of claim 1, having a viscosity of less than or equal to about 400 cP at about 3° C. (37° F.).

4. The well treatment fluid of claim 1, wherein the fluid is a homogeneous solution after storage at −40° C. for 1 week.

5. The well treatment fluid of claim 1, further comprising from about 0.01 wt % to less than or equal to about 10 wt % of methanol, ethanol, isopropanol, propanol, a colloidal silica dispersion, or a combination thereof.

6. The well treatment fluid of claim 1, further comprising from about 0.01 wt % to less than or equal to about 1 wt % of a chelating agent selected from the group consisting of: ethylenediaminetetraacetic acid, ethylene glycol tetraacetic acid, 1,2-bis(o-aminophenoxy)ethanetetraacetic acid, nitrilotriacetic acid, 4-hydroxybenzenesulfonic acid, and a combination thereof.

7. The well treatment fluid of claim 1, further comprising a cross-linkable polymer comprising guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

8. A method of treating a wellbore comprising:
introducing a well treatment fluid into a wellbore penetrating a subterranean formation, wherein the well treatment fluid comprises an aqueous solution comprising greater than or equal to about 1 wt % boron, at least 5 wt % of a co-solvent, and greater than or equal to about 5 wt % sodium hydroxide, potassium hydroxide, or a combination thereof, and wherein the co-solvent is glycerol, ethylene glycol, propylene glycol, or a combination thereof.

9. The method of claim 8, wherein the boron results from boric acid, a salt of boric acid, borax, or a combination thereof.

10. The method of claim 8, wherein the well treatment fluid has a viscosity of less than or equal to about 200 cP at about 3° C. (37° F.).

11. The method of claim 8, wherein the well treatment fluid is a homogeneous solution after storage at −40° C. for 1 week.

12. The method of claim 8, wherein the well treatment fluid further comprises from about 0.01 wt % to less than or equal to about 10 wt % of methanol, ethanol, isopropanol, propanol, a colloidal silica dispersion, or a combination thereof.

13. The method of claim 8, wherein the well treatment fluid further comprises from about 0.01 wt % to less than or equal to about 1 wt % of a chelating agent selected from the group consisting of: ethylenediaminetetraacetic acid, ethylene glycol tetraacetic acid, 1,2-bis(o-aminophenoxy)ethanetetraacetic acid, nitrilotriacetic acid, 4-hydroxybenzenesulfonic acid, and a combination thereof.

14. The method of claim 8, wherein the well treatment fluid further comprises a cross-linkable polymer.

15. The method of claim 14, wherein the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

16. A method of treating a wellbore comprising:
contacting a crosslinker solution with a mixture comprising a cross-linkable polymer to produce a well treatment fluid comprising a crosslinked polymer, and
introducing the well treatment fluid into the wellbore penetrating a subterranean formation, wherein the crosslinker solution comprises an aqueous solution comprising greater than or equal to about 3 wt % boron, at least 10 wt % of a co-solvent, and greater than or equal to about 10 wt % sodium hydroxide, potassium hydroxide, or a combination thereof, wherein the co-solvent is glycerol, ethylene glycol, propylene glycol, or a combination thereof and wherein the boron results from boric acid, a salt of boric acid, borax, or a combination thereof.

17. The method of claim 16, wherein the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

18. A method of treating a wellbore comprising:
introducing a crosslinker solution and a mixture comprising a cross-linkable polymer into a wellbore penetrating a subterranean formation, to produce a well treatment fluid comprising a crosslinked polymer within the wellbore;
wherein the crosslinker solution and the mixture comprising a cross-linkable polymer are introduced into the wellbore sequentially, simultaneously, or a combination thereof;
wherein the crosslinker solution comprises an aqueous solution comprising greater than or equal to about 3 wt % boron, at least 10 wt % of a co-solvent, and greater than or equal to about 10 wt % sodium hydroxide, potassium hydroxide, or a combination thereof; wherein the co-solvent is glycerol, ethylene glycol, propylene glycol, or a combination thereof; and wherein the boron results from boric acid, a salt of boric acid, borax, or a combination thereof.

19. The method of claim 18, wherein the cross-linkable polymer comprises guar, a guar derived polymer, polymethylmethacrylate, polyethyleneoxide, polyacrylamide, polymethacrylamide, partially hydrolyzed polyacrylamide, cationic polyacrylamide, polymers comprising dimethylamino ethyl methacrylate, 2-(methacryloyloxy)-ethyltrimethylammonium chloride, methacrylamidopropyl trimethyl ammonium chloride, diallyldimethylammonium chloride, 2-acrylamido-2-methylpropane sulfonic acid, or a combination thereof.

20. A method of reducing phase separation in a well treatment fluid comprising:
combining an amount of a co-solvent with an aqueous solution comprising greater than or equal to about 1 wt % boron and greater than or equal to about 5 wt % sodium hydroxide, potassium hydroxide, or a combination thereof, to produce the well treatment fluid comprising an aqueous solution comprising greater than or equal to about 1 wt % boron, at least 5 wt % of the co-solvent, and greater than or equal to about 5 wt % sodium hydroxide, potassium hydroxide, or a combination thereof; wherein the co-solvent is glycerol, ethylene glycol, propylene glycol, or a combination thereof.

21. A method of forming a crosslinked polymer comprising:
contacting a crosslinkable polymer with a crosslinking solution to produce the crosslinked polymer, wherein the crosslinking solution comprises an aqueous solution comprising greater than or equal to about 1 wt % boron, at least 5 wt % of the co-solvent, and greater than or equal to about 5 wt % sodium hydroxide, potassium hydroxide, or a combination thereof; wherein the co-solvent is glycerol, ethylene glycol, propylene glycol, or a combination thereof.
